(19) United States
(12) Patent Application Publication
(10) Pub. No.: US 2006/0034443 A1
(43) Pub. Date: Feb. 16, 2006

(54) Method of displaying a map containing locations, and accesses to information resources relating to said locations

(75) Inventor: Veronique Daurensan, Antony (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/198,336

(22) Filed: Aug. 8, 2005

(30) Foreign Application Priority Data
Aug. 9, 2004 (FR) 0408777

(51) Int. Cl. H04M 3/42; H04M 1/64

(52) U.S. Cl. 379/218.01; 379/88.17

(57) ABSTRACT

The invention relates to a method comprising: a step of a communications network server sending the map of a site to a mobile telephone; a main display step of displaying on the screen of the mobile telephone the map (1) and main icons (2) representing particular locations situated on the map; a secondary display step following the user of the mobile telephone selecting a main icon (2) of displaying on the screen of the mobile telephone a plurality of secondary icons (3) corresponding to respective information resources relating to the location corresponding to said selected main icon (2), the secondary display step requiring no more of the user of the mobile telephone than selecting the main icon (2); and a step following the user of the mobile telephone selecting a said secondary icon (2) of putting the user into communication with the information resource corresponding to said selected secondary icon (3), this step of putting the user into communication requiring no more of the user of the mobile telephone than selecting said secondary icon (3).

The present invention relates to the field of methods of displaying a map containing locations and accesses to information resources relating to said locations.

The invention also relates to a mobile telephone for implementing the method of the invention, and to an application server for implementing the method of the invention.

In the prior art, e.g. as described in the following documents: European patent application EP 1 189 027, European patent application EP 0 875 729, European patent application EP 0 642 108, Patent Abstracts of Japan JP 09 329 516, Patent Abstracts of Japan JP 07 266 700, U.S. Pat. No. 6,385,467, U.S. Pat. No. 5,289,572, US patent application No. U.S. 2002/0173906, methods are known for displaying a map containing locations and accesses to information resources relating to those locations. That prior art presents the drawback of a method that is relatively lengthy and complex to enable the user to access the desired information resource, often requiring not only a mobile telephone, but also a car navigation system, or sometimes relating to only one information resource per location, which is too restricting.

The invention proposes a method that is relatively simpler and faster, enabling a user to access information using only a mobile telephone.

The invention provides a method comprising: a step of a server in a communications network sending the map of a site to a mobile telephone; a main display step of displaying on the screen of the mobile telephone, the map and main icons representing particular locations situated on the map; a secondary display step of displaying on the screen of the mobile telephone, for at least one main icon after said main icon has been selected by the user of the mobile telephone, a plurality of secondary icons corresponding to respective information resources relating to the location corresponding to said selected main icon, at least two of the information resources being mutually distinct and reachable by the mobile telephone via the server using mutually distinct communications means, the secondary display step requiring no more of the user of the mobile telephone than selecting said main icon; and a step of putting into communication for at least one secondary icon corresponding to one of said mutually distinct information resources that are reachable by the mobile telephone via the server using mutually distinct communications means, on the user of the mobile telephone selecting said secondary icon, communication taking place over the information resource corresponding to said selected secondary icon via the server with the help of the communications means corresponding to the information resource corresponding to said selected secondary icon, the step of putting the user of the mobile telephone into communication requiring no more of the user than selecting said secondary icon.

The invention will be better understood and other features and advantages thereof will appear with the help of the following description and the accompanying drawing, given by way of example, and in which:

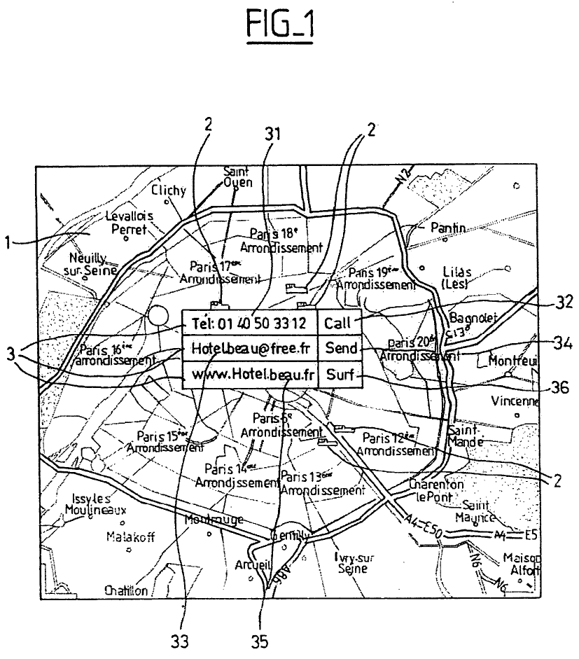

FIG. 1 is a diagram of a map displayed on the screen of a mobile telephone using the method of the invention.

FIG. 1 is a diagram of a map displayed on the screen of a mobile telephone using the method of the invention. An application server of a communications network sends a map 1 representing a site, e.g. a town, to a mobile telephone. The map 1 may represent the site where the user of the mobile telephone is located, or else any other site that the user has requested of the server. The mobile telephone displays the map 1 on its screen together with main icons 2 representing particular locations situated in the town, e.g. hotels, restaurants, museums, etc. From this position, the user can move a cursor on the screen and confirm the position of the cursor preferably when it is over a main icon 2, or least in the vicinity of said main icon 2. When a main icon 2 is selected, a family of secondary icons 3 is displayed giving information resources relating to the locations corresponding to the selected main icon 2. Each secondary icon 3 represents a given information resource corresponding to a given communications means that will enable the mobile telephone to reach the corresponding information resource. In this case, for the selected main icon 2, three secondary icons 3 are displayed. Each secondary icon 3 comprises, for example, two portions: a left portion describing the information resource, and a right portion describing the communications means giving access to the information resource represented by the secondary icon 3. Information resource 31 corresponds to a telephone number of a hotel which the user can access by the communications means 32, namely a telephone call. Information resource 33 corresponds to an e-mail address of the hotel which the user can access by the communications means 34 which comprises sending an e-mail. The information resource 35 corresponds to an address for the hotel's Internet site which the user can access by the communications means 36 comprising a request to navigate on said Internet site. By way of example, it suffices for the user to click on box 31 or on box 32 for the telephone number displayed in box 31 to be called directly by the user's mobile telephone without the user needing to dial said number on the mobile telephone. Similarly, merely by clicking on box 33 or box 34, the user can send an e-mail directly to the hotel (or can access an e-mail format already containing the hotel's address and merely requiring the body of the text to be filled in, e.g. in the form of an SMS). Also similarly, merely clicking on the boxes 35 or 36 enables the user to access the hotel's Internet site directly. In this case, the three secondary icons 3 constitute three mutually distinct information resources: telephone, e-mail, and Internet site, accessible by three mutually distinct communications means, namely a voice telephone call, transmitting an e-mail, and a link to an Internet site on which the user can subsequently navigate. In order to access all of the information resources relating to the locations represented on the map 1 by main icons, all the user needs to do is select a main icon 2 and select a secondary icon 3.

The secondary display step is preferably implemented for a plurality of main icons, and more advantageously for all of the main icons shown on the map. Also advantageously, the step of putting into communication can be implemented for all of the secondary icons of a plurality of main icons, or indeed more advantageously for all of the secondary icons of all of the main icons.

Selection preferably consists firstly in moving a cursor to one of the icons, and secondly in confirming the position to which the cursor has been moved.

Advantageously, confirmation consists in pressing once on a single key. It could also require two presses in quick succession on the same key, for example. An even simpler type of selection could be envisaged using a contact stylus held in the user's hand, which stylus confirms an icon merely by making contact with the corresponding portion of the screen where said icon is shown.

One of the communications means is preferably voice communication. That is where the invention is most advantageous; the mobile telephone is then the only appliance that the user needs, whereas in the prior art, using a car navigation system, the user also needs a car navigation system, the mobile telephone, and an electronic link between them, or else the user needs to dial the telephone number directly on the mobile telephone after reading it from the car navigation system.

The method is preferably implemented using a Java application located in the mobile telephone. The Java application sets up directly the link between the application server and the screen of the mobile telephone.

1. A method comprising:
a step of a server in a communications network sending the map (1) of a site to a mobile telephone;
a main display step of displaying on the screen of the mobile telephone, the map and main icons (2) representing particular locations situated on the map;
a secondary display step of displaying on the screen of the mobile telephone, for at least one main icon after said main icon has been selected by the user of the mobile telephone, a plurality of secondary icons (3) corresponding to respective information resources relating to the location corresponding to said selected main icon, at least two of the information resources being mutually distinct and reachable by the mobile telephone via the server using mutually distinct communications means, the secondary display step requiring no more of the user of the mobile telephone than selecting said main icon; and
a step of putting into communication for at least one secondary icon corresponding to one of said mutually distinct information resources that are reachable by the mobile telephone via the server using mutually distinct communications means, on the user of the mobile telephone selecting said secondary icon, communication taking place over the information resource corresponding to said selected secondary icon via the server with the help of the communications means corresponding to the information resource corresponding to said selected secondary icon, the step of putting the user of the mobile telephone into communication requiring no more of the user than selecting said secondary icon.

2. A method according to claim 1, characterized in that the secondary display step can be implemented for a plurality of main icons.

3. A method according to claim 1, characterized in that the step of putting into communication can be implemented for all of the secondary icons of a plurality of main icons.

4. A method according to claim 2, characterized in that the step of putting into communication can be implemented for all of the secondary icons of a plurality of main icons.

5. A method according to claim 1, characterized in that the selection step comprises firstly of moving a cursor to one of the icons, and secondly of confirming the position of the moved cursor.

6. A method according to claim 2, characterized in that the selection step comprises firstly of moving a cursor to one of the icons, and secondly of confirming the position of the moved cursor.

7. A method according to claim 3, characterized in that the selection step comprises firstly of moving a cursor to one of the icons, and secondly of confirming the position of the moved cursor.

8. A method according to claim 5, characterized in that confirmation comprises of a single press on a single key.

9. A method according to claim 1, characterized in that one of the communications means is voice communication.

10. A method according to claim 2, characterized in that one of the communications means is voice communication.

11. A method according to claim 3, characterized in that one of the communications means is voice communication.

12. A method according to claim 5, characterized in that one of the communications means is voice communication.

13. A method according to claim 1, characterized in that the method is implemented using a Java application located in the mobile telephone.

14. A mobile telephone for implementing the method according to claim 1.

15. A mobile telephone for implementing the method according to claim 2.

16. A mobile telephone for implementing the method according to claim 3.

17. An application server for implementing the method according to claim 1.

18. An application server for implementing the method according to claim 2.

19. An application server implementing the method according to claim 3.
